(19) United States
(12) Patent Application Publication
(10) Pub. No.: US 2012/0162380 A1
(43) Pub. Date: Jun. 28, 2012

(54) OPTICAL MODULATOR USING MULTIPLE FABRY-PEROT RESONANT MODES AND APPARATUS FOR CAPTURING 3D IMAGE INCLUDING THE OPTICAL MODULATOR

(75) Inventors: Yong-chul CHO, Suwon-si (KR); Yong-Tak LEE, Gwangju (KR); Yong-Hwa PARK, Yongin-si (KR); Byung-Hoon NA, Seoul (KR)

(73) Assignees: GWANGJU INSTITUTE OF SCIENCE AND TECHNOLOGY, Gwangju (KR); SAMSUNG ELECTRONICS CO., LTD., Suwon-si (KR)

(21) Appl. No.: 13/163,202

(22) Filed: Jun. 17, 2011

(30) Foreign Application Priority Data
Dec. 28, 2010 (KR) 10-2010-0137229

(51) Int. Cl. G02F 1/01; H04N 13/02; B82Y 20/00

(52) U.S. Cl. 348/47; 359/260; 977/755; 348/E13.074

(57) ABSTRACT

An optical modulator that performs wide bandwidth optical modulation by using multiple Fabry-Perot resonant modes, and an apparatus for capturing a three-dimensional image including the optical modulator are provided. The optical modulator may include: a substrate; a first contact layer disposed on the substrate; a bottom distributed Bragg reflective (DBR) layer disposed on the first contact layer; an active layer disposed on the bottom DBR layer and includes a multiple quantum well layer; a top DBR layer disposed on the active layer; a cavity layer disposed in the top DBR layer; and a second contact layer disposed on the top DBR layer. Since the optical modulator achieves both a high contrast ratio and a wide bandwidth by using two or more Fabry-Perot resonant modes, the optical modulator may show a stable performance even when a resonant wavelength is changed during manufacture or due to an external environment such as temperature.

### CROSS-REFERENCE TO RELATED APPLICATION

This application claims priority from Korean Patent Application No. 10-2010-0137229, filed on Dec. 28, 2010 in the Korean Intellectual Property Office, the disclosure of which is incorporated herein in its entirety by reference.

### BACKGROUND

1. Field

Apparatuses and methods consistent with exemplary embodiments relate to optical modulators and apparatuses for capturing three-dimensional (3D) images, and more particularly, to optical modulators which may perform wide bandwidth optical modulation by using multiple Fabry-Perot resonant modes, and apparatuses for capturing 3D images including the optical modulators.

2. Description of the Related Art

An image captured by a general camera does not include information about distance. In order to realize an apparatus for capturing a three-dimensional (3D) image such as a 3D camera, an additional unit for measuring a distance from a plurality of points on a surface of an object is required.

Distance information about an object is generally obtained by using a binocular stereovision method using two cameras or a triangulation method using structured light and a camera. However, according to the two methods, the accuracy of the distance information is sharply reduced when a distance between an object and a camera increases. Also, these methods are dependent on a surface state of the object and, thus, precise distance information may not be obtained.

In order to obtain more precise distance information, a time-of-flight (TOF) method has been introduced. The TOF method irradiates a laser beam on an object and measures a TOF of a light until the light is received by a light receiver after being reflected off the object. According to the TOF method, light having a certain wavelength, such as near infrared rays of 850 nm, is projected to the object by using a light-emitting diode (LED) or a laser diode (LD), such that the light receiver receives a light having the same wavelength and reflected from the object, and then special processes are performed to extract distance information. Various TOF methods based on such a series of processes have been suggested. For example, a TOF method using direct time measurement involves measuring a time taken for a pulse light to be projected to an object and reflected from the object by using a timer. Also, a TOF method using correlation involves projecting a pulse light to an object and measuring a distance by using information about brightness of a light that is reflected from the object. A TOF method using phase delay measurement involves projecting a light having a continuous sinusoidal wave to an object and detecting a phase difference of a light reflected from the object to calculate a distance.

Also, there are many examples of the phase delay measurement. From among them, for example, external modulation involves performing amplitude modulation on a reflected light by using an optical modulator, capturing the modulated reflected light by using an image sensor, and measuring a phase delay. It is easy to obtain a high resolution distance image by using the external modulation. The external modulation method, however, requires an optical modulator capable of modulating a light at a high speed of several tens to several hundreds of MHz in order to obtain a precise phase delay. Accordingly, various types of optical modulators, such as an image intensifier including a multi-channel plate (MCP), a thin modulator device using an electro-optic (EO) material, and a gallium arsenide (GaAs)-based solid modulator device have been suggested.

For example, the image intensifier includes a photocathode for converting a light into electrons, an MCP for amplifying the number of electrons, and a phosphor for converting the electrons back to light. However, the image intensifier occupies a large volume, uses a high voltage of several kV, and is expensive. Also, the thin modulator device using the EO material uses a refractive index change of a nonlinear crystalline material according to a voltage as an operating principle. Such a thin modulator device using the EO material is thick and also requires a high voltage.

Recently, a GaAs semiconductor-based modulator that is easily manufactured, small, and operable with a low voltage has been suggested. The GaAs semiconductor-based modulator includes a multiple quantum well (MQW) layer disposed between a P-electrode and an N-electrode, and uses a phenomenon of the MQW layer absorbing a light when a reverse bias voltage is applied to each end of the P- and N-electrodes. The GaAs-based modulator has advantages in that it may operate at high speed, has a relatively low driving voltage, and has a high reflectivity difference (i.e., contrast ratio) during on/off cycles. However, a bandwidth of a modulator of the GaAs semiconductor-based optical modulator is about 4 nm to about 5 nm, which is very narrow. A 3D camera uses several light sources, and there are differences between center wavelengths of the light sources. Also, a center wavelength of a light source may change according to temperature. Similarly, a center absorption wavelength of an optical modulator changes according to a process variable during manufacture and temperature. Accordingly, in order to apply the optical modulator to the 3D camera, the optical modulator needs to be capable of performing wide bandwidth optical modulation. However, since there is a trade-off between a reflectivity difference during on/off cycles and a bandwidth, it is difficult to increase both the reflectivity difference during on/off cycles and the bandwidth.

### SUMMARY

Aspects of one or more exemplary embodiments provide optical modulators having a high contrast ratio and a wide bandwidth by using multiple Fabry-Perot resonant modes.

Moreover, aspects of one or more exemplary embodiments provide apparatuses for capturing three-dimensional (3D) images including the optical modulators.

Additional aspects will be set forth in part in the description which follows and, in part, will be apparent from the description, or may be learned by practice of the presented embodiments.

According to an aspect of an exemplary embodiment, there is provided an optical modulator including: a bottom reflective layer; an active layer that is disposed on the bottom reflective layer and including a multiple quantum well layer; a top reflective layer that is disposed on the active layer; and at least one cavity layer that is disposed in the top reflective layer, wherein, when a center wavelength of an incident light to be modulated is λ, each of the active layer and the at least one cavity layer has an optical thickness that is an integer multiple of λ/2 in order to form an individual resonant cavity.

The optical thickness of the active layer may be 2λ, and the optical thickness of the at least one cavity layer may be λ/2.

One cavity layer may be disposed in the top reflective layer, wherein the top reflective layer includes a first top reflective layer that is disposed on the active layer, the one cavity layer that is disposed on the first top reflective layer, and a second top reflective layer that is disposed on the one cavity layer.

A phase of a light directly reflected from the second top reflective layer may be π, and a phase of each of a light resonated in the one cavity layer and then reflected from the first top reflective layer and a light resonated in the active layer and then reflected from the bottom reflective layer may be 0.

Each of the bottom reflective layer, the first top reflective layer, and the second top reflective layer may be a distributed Bragg reflective (DBR) layer that is formed by repeatedly alternately stacking a first refractive index layer and a second refractive index layer with different refractive indices, each of the first and second refractive index layers having an optical thickness of λ/4.

The one cavity layer may be formed of a material of the first refractive index layer or a material of the second refractive index layer.

If the one cavity layer is formed of the material of the first refractive index layer, the second refractive index layer of the first top reflective layer may be disposed under the one cavity layer to contact the one cavity layer, and the second refractive index layer of the second top reflective layer may be disposed above the one cavity layer to contact the one cavity layer.

If the one cavity layer is formed of the material of the second refractive index layer, the first refractive index layer of the first top reflective layer may be disposed under the one cavity layer to contact the one cavity layer and the first refractive index layer of the second top reflective layer may be disposed above the one cavity layer to contact the one cavity layer.

The first refractive index layer may include AlₓGa₁₋ₓAs, the second refractive index layer may include Al_{y}Ga_{1-y}As, and 0<x<1, 0<y<1, and x<y.

A reflectivity of the bottom reflective layer may be about 98% to 99%, a reflectivity of the first top reflective layer may be about 90%, and a reflectivity of the second top reflective layer may be about 60% to 70%.

Two Fabry-Perot resonant modes may occur due to the active layer and the one cavity layer, and center values of two resonant wavelengths may be equal to the center wavelength λ of the incident light to be modulated.

Two cavity layers may be disposed in the top reflective layer, wherein the top reflective layer includes a first top reflective layer that is disposed on the active layer, a first cavity layer that is disposed on the first top reflective layer, a second top reflective layer that is disposed on the first cavity layer, a second cavity layer that is disposed on the second top reflective layer, and a third top reflective layer that is disposed on the second cavity layer.

A phase of a light directly reflected from the third top reflective layer may be π, a phase of a light resonated in the second cavity layer and then reflected from the second reflective layer may be 0, a phase of a light resonated in the first cavity layer and reflected from the first top reflective layer may be π, and a phase of a light resonated in the active layer and then reflected from the bottom reflective layer may be 0.

Each of the bottom reflective layer and the first through third top reflective layers may be a DBR layer that is formed by repeatedly alternately stacking a first refractive index layer and a second refractive index layer with different refractive indices, each of the first and second refractive index layers having an optical thickness of λ/4.

The first cavity layer may be formed of a material of the first refractive index layer or a material of the second refractive index layer, and the second cavity layer may be formed of the material of the first refractive index layer or the material of the second refractive index layer.

If the first cavity layer is formed of the material of the first refractive index layer, the second refractive index layer of the first top reflective layer may be disposed under the first cavity layer to contact the first cavity layer and the second refractive index layer of the second top reflective layer may be disposed above the first cavity layer to contact the first cavity layer.

If the first cavity layer is formed of the material of the second refractive index layer, the first refractive index layer of the first top reflective layer may be disposed under the first cavity layer to contact the first cavity layer and the first refractive index layer of the second top reflective layer may be disposed above the first cavity layer to contact the first cavity layer.

If the second cavity layer is formed of the material of the first refractive index layer, the second refractive index layer of the second top reflective layer may be disposed under the second cavity layer to contact the second cavity layer and the second refractive index layer of the third top reflective layer may be disposed above the second cavity layer to contact the second cavity layer.

If the second cavity layer is formed of the material of the second refractive index layer, the first refractive index layer of the second top reflective layer may be disposed under the second cavity layer to contact the second cavity layer and the first refractive index layer of the third top reflective layer may be disposed above the second cavity layer to contact the second cavity layer.

A reflectivity of the bottom reflective layer may be about 98% to 99%, a reflectivity of the first top reflective layer may be about 91%, a reflectivity of the second top reflective layer may be about 93%, and a reflectivity of the third top reflective layer may be about 46%.

Three Fabry-Perot resonant modes may occur due to the active layer and the first and second cavity layers, and center values of three resonant wavelengths may be equal to the center wavelength λ of the incident light to be modulated.

When an exciton absorption wavelength due to the active layer is λ_{EX} and a shortest resonant wavelength from among resonant wavelengths of Fabry-Perot resonant modes generated due to the at least one cavity layer is λ_{FP1}, λ_{EX}+10 nm<λ_{FP1}.

The active layer may include a plurality of barrier layers and a plurality of quantum well layers which are alternately disposed.

When an incident angle of the incident light on a surface of the top reflective layer is θₜ₀, a refraction angle of the incident light on the top reflective layer is θₜ₁, and a refraction angle of the incident light on the active layer is θₜ₂, thicknesses of the first and second refractive index layers and a thickness of the cavity layer may be increased by a multiple of a reciprocal of cos(θₜ₁) and a thickness of the active layer may be increased by a multiple of a reciprocal of cos(θₜ₁).

The optical modulator may further include: a first contact layer that is disposed under the bottom reflective layer; a substrate that is disposed under the first contact layer; and a second contact layer that is disposed above the top reflective layer.

According to an aspect of another exemplary embodiment, there is provided an optical modulator array including: an insulating frame; a plurality of the optical modulators within the insulating frame; a trench surrounding each of the optical modulators; a first electrode that is disposed on a bottom surface of the trench; a second electrode that is disposed on a top surface of each of the optical modulators; a first electrode pad that is disposed on a top surface of the insulating frame and is electrically connected to the first electrode; and a second electrode pad that is disposed on the top surface of the insulating frame and is electrically connected to the second electrode.

The optical modulator array may further include an insulating film that surrounds a sidewall of the optical modulators.

The optical modulator array may further include an adhesive layer that is disposed between the first electrode pad and the insulating frame and between the second electrode pad and the insulating frame.

A first contact layer, which is disposed under the bottom reflective layer of the optical modulator, may be disposed on the bottom surface of the trench, and the first electrode may be disposed on the first contact layer.

The first electrode may extend along a sidewall of the trench to be electrically connected to the first electrode pad.

The second electrode may have a lattice shape.

The second electrode may have a fishbone shape or a matrix shape.

According to an aspect of another exemplary embodiment, there is provided an apparatus for capturing a 3D image, the apparatus including: a light source that projects a light to an object; the optical modulator that modulates a light reflected from the object; an imager that captures a light modulated by the optical modulator and generates an image; and a calculator that calculates a distance to the object by using the image generated by the imager.

### BRIEF DESCRIPTION OF THE DRAWINGS

These and/or other aspects will become apparent and more readily appreciated from the following description of exemplary embodiments, taken in conjunction with the accompanying drawings of which:

FIG. 1 is a cross-sectional view illustrating an optical modulator according to an exemplary embodiment;

FIG. 2 is a cross-sectional view for explaining an operation of the optical modulator of FIG. 1;

FIG. 3 is a graph illustrating a reflectivity of the optical modulator of FIG. 1 and a total phase of a reflected light according to a wavelength of an incident light when no voltage is applied to the optical modulator;

FIG. 4 is a table showing optimal materials and thicknesses of layers of the optical modulator of FIG. 1, according to an exemplary embodiment;

FIG. 5 is a table showing optimal materials and thicknesses of layers of the optical modulator of FIG. 1, according to another exemplary embodiment;

FIG. 6 is a graph illustrating a reflectivity when no voltage is applied to the optical modulator and a reflectivity when a voltage is applied to the optical modulator according to an exemplary embodiment;

FIG. 7 is a graph illustrating a reflectivity difference when no voltage is applied and a voltage is applied to the optical modulator of FIG. 4 or 5;

FIG. 8 is a cross-sectional view for explaining an operation of an optical modulator including two cavity layers in a top distributed Bragg reflective (DBR) layer, according to another exemplary embodiment;

FIG. 9 is a table showing optimal materials and thicknesses of the optical modulator of FIG. 8;

FIG. 10 is a graph illustrating a reflectivity when no voltage is applied to the optical modulator of FIG. 9 and a reflectivity when a voltage is applied to the optical modulator;

FIG. 11 is a graph illustrating a reflectivity difference when no voltage is applied and when a voltage is applied to the optical modulator of FIG. 9;

FIG. 12 is a cross-sectional view illustrating an optical path according to an incident angle of an obliquely incident light incident on the optical modulator of FIG. 4, 5, or 9;

FIG. 13 is a table showing optimal materials and thicknesses of a modified optical modulator of the optical modulator of FIG. 4, which considers an obliquely incident light according to an exemplary embodiment;

FIGS. 14 and 15 are graphs illustrating operation characteristics of the modified optical modulator of FIG. 13;

FIG. 16 is a cross-sectional view illustrating an example where a light is focused by a lens on a surface of an optical modulator according to an exemplary embodiment;

FIG. 17 is a plan view illustrating an optical modulator array including an array of optical modulators according to an exemplary embodiment;

FIG. 18 is a cross-sectional view taken along line A-A′ of FIG. 17;

FIG. 19 is a cross-sectional view taken along line B-B′ of FIGS. 17; and

FIG. 20 is a view illustrating an apparatus for capturing a three-dimensional (3D) image including the optical modulator array of FIG. 17 according to an exemplary embodiment.

### DETAILED DESCRIPTION OF EXEMPLARY EMBODIMENTS

Exemplary embodiments will now be described more fully with reference to the accompanying drawings. In the drawings, like reference numerals denote like elements, and sizes of elements may be exaggerated for clarity.

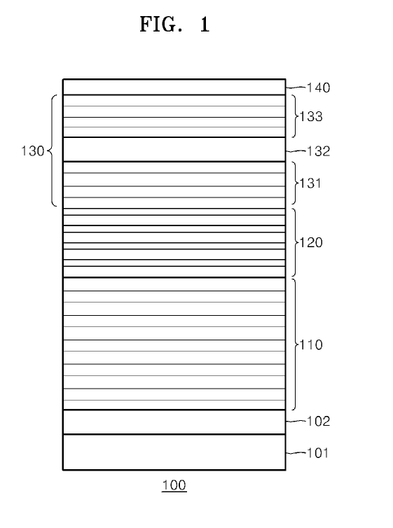

FIG. 1 is a cross-sectional view illustrating an optical modulator 100 according to an exemplary embodiment. Referring to FIG. 1, the optical modulator 100 may include a substrate 101, a first contact layer 102 disposed on the substrate 101, a bottom distributed Bragg reflective (DBR) layer 110 disposed on the first contact layer 102, an active layer 120 disposed on the bottom DBR layer 110 and having a multiple quantum well layer structure, a top DBR layer 130 disposed on the active layer 120, a cavity layer 132 disposed in the top DBR layer 130, and a second contact layer 140 disposed on the top DBR layer 130.

The substrate 101 may be formed of, for example, undoped gallium arsenide (GaAs). The first contact layer 102, which is a layer for connecting to an electrode (not shown) for applying a voltage to the active layer 120, may be formed of, for example, silicon-doped n-GaAs. Also, the second contact layer 140, which is a layer for connecting to another electrode (not shown) for applying a voltage to the active layer 120, may be formed of, for example, a beryllium (Be)-doped p-GaAs.

Each of the bottom DBR layer 110 and the top DBR layer 130 has a structure in which a low refractive index layer with a relatively low refractive index and a high refractive index layer with a relatively high refractive index are repeatedly alternately stacked. For example, each of the bottom and top DBR layers 110 and 130 may include pairs of the high refractive index layer and the low refractive index layer respectively including AlₓGa₁₋ₓAs and Al_{y}Ga_{1-y}As, where 0<x<1, 0<y<1, and x<y. For example, each of the bottom and top DBR layers 110 and 130 may have a structure in which Al_{0.31}Ga_{0.69}As and Al_{0.84}Ga_{0.16}As are repeatedly stacked, or Al_{0.5}Ga_{0.5}As and AlAs are repeatedly stacked.

If a light having a specific wavelength is incident on the bottom and top DBR layers 110 and 130 constructed as described above, reflection occurs on an interface between two layers with different refractive indices (that is, the high refractive index layer and the low refractive index layer) in the bottom and top DBR layers 110 and 130. In this case, a high reflectivity is achieved by enabling phase differences of all reflected lights to be the same. To this end, an optical thickness, which is obtained by multiplying a physical thickness by a refractive index of a corresponding layer, of each layer in the bottom and top DBR layers 110 and 130 is adjusted to be an odd multiple of λ/4 (where λ is a wavelength of an incident light to be modulated). A reflectivity of each of the bottom and top DBR layers 110 and 130 increases as the number of times pairs of the high refractive index layer and the low refractive index layer increases. Also, each of the bottom and top DBR layers 110 and 130 acts as a path through which current flows to be transmitted to the active layer 120. To this end, the bottom DBR layer 110 may be, for example, a Si-doped n-DBR layer, and the top DBR layer 130 may be, for example, a Be-doped p-DBR layer.

The active layer 120, which is a layer for absorbing a light, has a multiple quantum well layer structure in which a plurality of quantum well layers and a plurality of barrier layers are repeatedly stacked. For example, the active layer 120 may include barrier layers each formed of Al_{0.31}Ga_{0.69}As and quantum well layers each formed of GaAs. The active layer 120 may also act as a cavity for Fabry-Perot resonance. To this end, an optical thickness of the active layer 120 may be adjusted to be equal to an integer multiple of λ/2. Accordingly, a light having a wavelength λ may be sufficiently absorbed in the active layer 120 while being resonated between the bottom DBR layer 110 and the top DBR layer 130. For example, an optical thickness of the active layer 120 may be 2.0*λ. In general, as a thickness of the active layer 120 increases, an absorptivity increases and a driving voltage increases, and as a thickness of the active layer 120 decreases, an absorptivity decreases and a driving voltage decreases.

The cavity layer 132 is further disposed in the top DBR layer 130. The cavity layer 132 acts as an additional micro cavity for Fabry-Perot resonance. To this end, an optical thickness of the cavity layer 132 may be adjusted to be equal to an integer multiple of λ/2. For example, an optical thickness of the cavity layer 132 may be λ/2. The cavity layer 132 may be formed of a single material. For example, a material of the cavity layer 132 may be the same as that of the high refractive index layer (e.g., Al_{0.31}Ga_{0.69}As or Al_{0.5}Ga_{0.5}As) of the top DBR layer 130 or that of the low refractive index layer (e.g., Al_{0.84}Ga_{0.16}As or AlAs) of the top DBR layer 130. Also, the cavity layer 132 is p-type doped to transmit current to the active layer 120, like the top DBR layer 130.

The top DBR layer 130 is divided into two parts by the cavity layer 132. That is, a first top DBR layer 131 is disposed under the cavity layer 132 and a second top DBR layer 133 is disposed above the cavity layer 132. In this case, in the entire structure including the first top DBR layer 131, the cavity layer 132, and the second top DBR layer 133, an order in which the high refractive index layer and the low refractive index layer are repeatedly stacked is maintained. For example, if the cavity layer 132 is formed of a material of the high refractive index layer, a layer disposed under the cavity layer 132 to contact the cavity layer 132 is the low refractive index layer of the first top DBR layer 131, and a layer disposed above the cavity layer 132 to contact the cavity layer 132 is the low refractive index layer of the second top DBR layer 133. If the cavity layer 132 is formed of a material of the low refractive index layer, a layer disposed under the cavity layer 132 to contact the cavity layer 132 is the high refractive index layer of the first top DBR layer 131, and a layer disposed above the cavity layer 132 to contact the cavity layer 132 is the high refractive index layer of the second top DBR layer 133. In this regard, the cavity layer 132 can be considered such that any one of a plurality of the high refractive index layers and the low refractive index layers in the top DBR layer 130 is formed to have an optical thickness of λ/2, not λ/4.

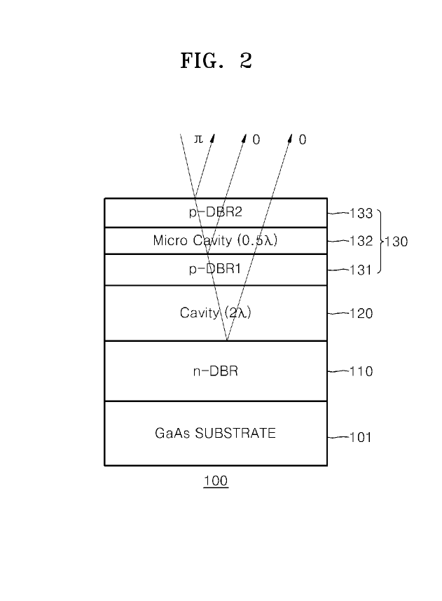

FIG. 2 is a cross-sectional view for explaining an operation of the optical modulator 100 of FIG. 1. Referring to FIG. 2, the optical modulator 100 includes three reflective layers, that is, the bottom DBR layer 110, the first top DBR layer 131, and the second top DBR layer 133. Furthermore, the optical modulator 100 includes two resonant cavities, that is, the active layer 120 and the cavity layer 132. The active layer 120 acts as a main resonant cavity, and the bottom DBR layer 110 and the first top DBR layer 131 are respectively disposed under and above the active layer 120 for Fabry-Perot resonance. Also, the cavity layer 132 acts as an additional micro-resonant cavity, and the first top DBR layer 131 and the second top DBR layer 133 are respectively disposed under and above the cavity layer 132 for Fabry-Perot resonance. Although both the active layer 120 and the cavity layer 132 act as resonant cavities, light absorption occurs only in the active layer 120 having a multiple quantum well layer structure and the cavity layer 132 only causes Fabry-Perot resonance.

In this structure, when a light is incident on a top surface of the optical modulator 100, three reflective lights with different phases are generated. That is, a light directly reflected from the second top DBR layer 133 has a phase of π, a light resonated in the cavity layer 132 and then reflected from the first top DBR layer 131 and a light resonated in the active layer 120 and then reflected from the bottom DBR layer 110 have a phase of 0. Accordingly, the light reflected from the second top DBR layer 133 is offset by the lights reflected from the first top DBR layer 131 and the bottom DBR layer 110. To this end, a position of the cavity layer 132 in the top DBR layer 130 and reflectivities of the reflective layers, the bottom, first, and second DBR layers 110, 131, and 133, may vary by design. For example, the bottom DBR layer 110 may have a reflectivity of 98% to 99% for a light having a wavelength of about 850 nm in order to maximize light absorption in the active layer 120, and a reflectivity of the second top DBR layer 133 may be about 60% to 70% and a reflectivity of the first top DBR layer 131 may be about 90% in order for part of a light to reach the active layer 120. Also, a reflected light may have a desired phase by adjusting the number of pairs of the high refractive index layer and the low refractive index layer in the first top DBR layer 131 and the number of pairs of the high refractive index layer and the low refractive index layer in the second top DBR layer 133.

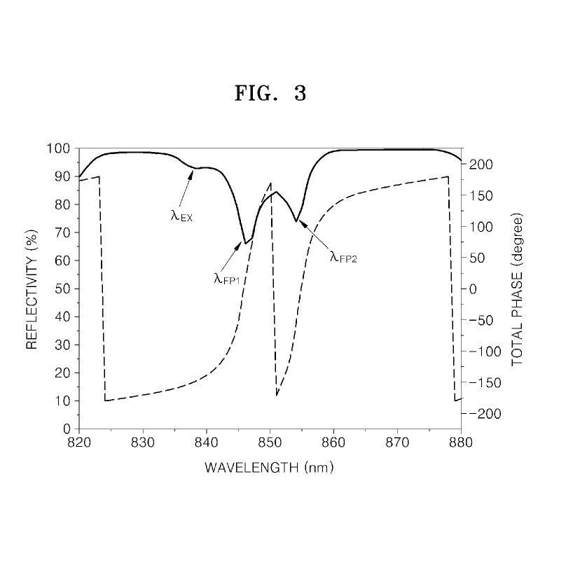

As described above, since the optical modulator 100 according to the present exemplary embodiment has two resonant cavities, there are two Fabry-Perot resonant modes. FIG. 3 is a graph illustrating a reflectivity of the optical modulator 100 of FIG. 1 and a total phase of a reflected light according to a wavelength of an incident light when no voltage is applied to the optical modulator 100. As shown in FIG. 3, two Fabry-Perot resonant modes occur around about 850 nm. That is, center values of two Fabry-Perot resonant wavelengths λ_{FP1} and λ_{FP2} are equal to 850 nm, which is a wavelength of an incident light to be modulated. Also, a total phase of reflected lights is 0 at around the two Fabry-Perot resonant wavelengths λ_{FP1} and λ_{FP2}, and a large phase shift of about 360 degrees occurs in a narrow section of about 10 nm between the two resonant wavelengths λ_{FP1} and λ_{FP2}. Also, exciton absorption by the quantum well layers in the active layer 120 occurs at a wavelength λ_{EX} of about 837 nm.

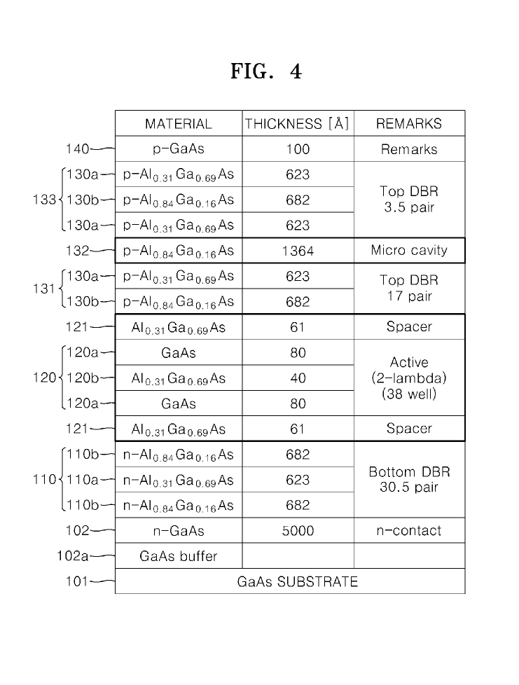

FIG. 4 is a table showing optimal materials and thicknesses of layers of the optical modulator 100 of FIG. 1, according to an exemplary embodiment. The optical modulator 100 illustrated in FIG. 4 is designed to have a center absorption wavelength of about 850 nm by using a GaAs compound semiconductor. Referring to FIG. 4, the second contact layer 140, which acts as a p-contact layer, is formed of p-GaAs. Since a GaAs material has a low surface oxidation rate and a small band gap, it is easy to form an Ohmic contact to form an electrode by using the GaAs material. A thickness of the second contact layer 140 may be about 100 Å in consideration of light absorption.

The second top DBR layer 133 disposed under the second contact layer 140 has a structure in which a high refractive index layer 130a and a low refractive index layer 130b are sequentially stacked downward. The high refractive index layer 130a may be formed of, for example, Al_{0.31}Ga_{0.69}As with a refractive index of about 3.413. In this case, a thickness of the high refractive index layer 130a may be about 623 Å. Thus, an optical thickness of the high refractive index layer 130a may be λ/4 (=850 nm/4=physical thickness×refractive index (=623 Å×3.413)). Also, the low refractive index layer 130b may be formed of, for example, Al_{0.84}Ga_{0.16}As with a refractive index of about 3.102. In this case, a thickness of the low refractive index layer 130b may be about 682 Å. Thus, an optical thickness of the low refractive index layer 130b may be λ/4 (=850 nm/4=physical thickness x refractive index (=682 Å×3.102)). In FIG. 4, the second top DBR layer 133 has 3.5 pairs of the high refractive index layer 130a and the low refractive index layer 130b. That is, the high refractive index layer 130a and the low refractive index layer 130b are sequentially repeatedly stacked 3 times downward and the high refractive index layer 130a is further disposed.

The cavity layer 132 is disposed under the second top DBR layer 133. Since the high refractive index layer 130a is a lowermost layer of the second top DBR layer 133, the cavity layer 132 may be formed of Al_{0.84}Ga_{0.16}As, as the low refractive index layer 130b. In this case, in order to have an optical thickness of λ/2, a thickness of the cavity layer 132 may be about 1364 Å.

Also, the first top DBR layer 131 is disposed under the cavity layer 132. Like the second top DBR layer 133, the first top DBR layer 131 also has a structure in which the high refractive index layer 130a and the low refractive index layer 130b are repeatedly stacked. Since the cavity layer 132 is formed of the same material as that of the low refractive index layer 130b, the high refractive index layer 130a is a first layer disposed under the cavity layer 132. The first top DBR layer 131 may have 17 pairs of the high refractive index layer 130a and the low refractive index layers 130b, though it is understood that another exemplary embodiment is not limited thereto.

As described above, the first top DBR layer 131, the cavity layer 132, and the second top DBR layer 133 act as paths through which current flows. Accordingly, materials of the first top DBR layer 131, the cavity layer 132, and the second top DBR layer 133 may be p-doped by using Be as a dopant. A doping density may be about 8.0×10¹⁸/cm³ to 1.2×10¹⁹/cm³.

The active layer 120, which absorbs a light and acts as a main resonant cavity, is disposed under the first top DBR layer 131. The active layer 120 may include, for example, a plurality of quantum well layers 120a each formed of GaAs, and a plurality of barrier layers 120b each formed of Al_{0.31}Ga_{0.69}As and disposed between the plurality of quantum well layers 120a. For example, the active layer 120 may have a multiple quantum well layer structure including 38 quantum well layers 120a. A total thickness of the active layer 120 is determined such that the active layer 120 has an optical thickness of 2λ. For example, if the active layer 120 includes 38 quantum well layers 120a, a thickness of the quantum well layer 120a may be about 80 Å, and a thickness of the barrier layer 120b may be about 40 Å.

Also, since a refractive index of GaAs, which is a material of the quantum well layer 120a, is about 3.702, which is high, an incident light may be reflected between the low refractive index layer 130b of the first top DBR layer 131 and the quantum well layer 120a, thereby leading to light loss. Accordingly, in order to minimize light loss and correct a thickness error of the active layer 120, a spacer layer 121 with an intermediate refractive index may be further disposed between the low refractive index layer 130b of the first top DBR layer 131 and the quantum well layer 120a of the active layer 120. For example, the spacer layer 121 may be formed of Al_{0.31}Ga_{0.69}As with a refractive index of about 3.413. For the same reason, the spacer layer 121 may be further disposed between the bottom DBR layer 110 and the active layer 120. A thickness of the spacer layer 121 may be about 61 Å.

The bottom DBR layer 110 is disposed under the active layer 120. The bottom DBR layer 110 has a structure in which a low refractive index layer 110b and a high refractive index layer 110a are sequentially repeatedly stacked downward. The low refractive index layer 110b may be formed of, for example, Al_{0.84}Ga_{0.16}As and a thickness of the low refractive index layer 110b may be about 682 Å (that is, an optical thickness of the low refractive index layer 110 may be λ/4). The high refractive index layer 110a may be formed of, for example, Al_{0.31}Ga_{0.69}As, and a thickness of the high refractive index layer 110a may be about 623 Å. The bottom DBR layer 110 has a high reflectivity of higher than 98% in order to maximize light absorption in the active layer 120. To this end, the bottom DBR layer 110 may include many pairs of the low refractive index layer 110b and the high refractive index layer 110a. In FIG. 4, the bottom DBR layer 110 has 30.5 pairs of the low refractive index layer 110b and the high refractive index layer 11a. That is, after the low refractive index layer 110b and the high refractive index layer 110a are sequentially repeatedly stacked downward 30 times, the low refractive index layer 110b is further disposed. The bottom DBR layer 110 also acts as a path through which current flows. Accordingly, the bottom DBR layer 110 may be n-doped by using, for example, Si as a dopant. For example, a doping density may be 2.0 to 2.6×10¹⁸/cm³.

Also, the first contact layer 102 formed of n-GaAs with a thickness of about 5000 Å is disposed under the bottom DBR layer 110. The first contact layer 102 may be directly formed (i.e., disposed)on the substrate 101 formed of GaAs, or a buffer layer 102a formed of GaAs may be disposed between the first contact layer 102 and the substrate 101.

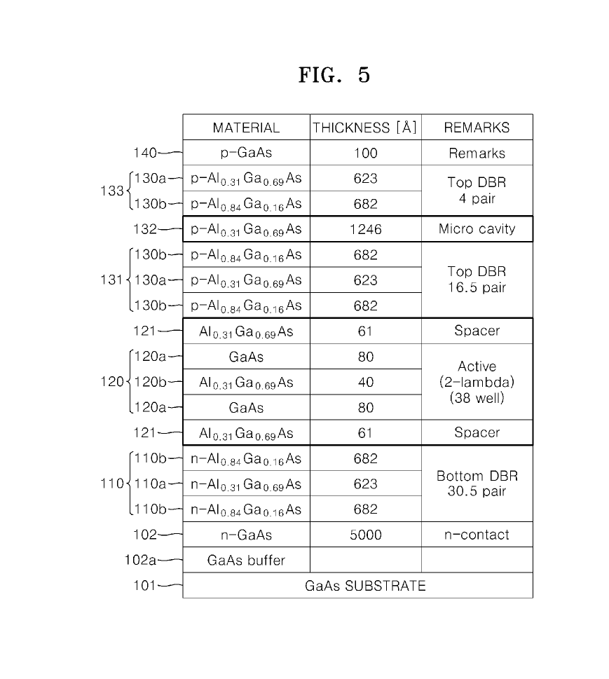

In FIG. 4, the cavity layer 132 is formed of the same material as that of the low refractive index layer 130b of the top DBR layer 130. However, the cavity layer 132 may be formed of the same material as that of the high refractive index layer 130a of the top DBR layer 130. FIG. 5 is a table showing optimal materials and thicknesses of layers of the optical modulator 100 of FIG. 1, in which the cavity layer 132 is formed of the same material as that of the high refractive index layer 130a, according to another exemplary embodiment. As compared to the optical modulator 100 of FIG. 4, only structures of the top DBR layer 130 and the cavity layer 132 are slightly different and structures of the other layers including the active layer 120 and the bottom DBR layer 110 are the same. Accordingly, the following explanation will focus on the differences between FIG. 4 and FIG. 5.

Referring to FIG. 5, the second top DBR layer 133 has a structure in which the high refractive index layer 130a and the low refractive index layer 130b are repeatedly stacked downward. As described above, the high refractive index layer 130a may be formed of Al_{0.31}Ga_{0.69}As and may have a thickness of about 623 Å. Also, the low refractive index layer 130b may be formed of Al_{0.84}Ga_{0.16}As and may have a thickness of about 682 Å. In FIG. 5, the second top DBR layer 133 has 4 pairs of the high refractive index layer 130a and the low refractive index layer 130b. That is, the high refractive index layer 130a and the low refractive index layer 130b are repeatedly stacked 4 times downward. Accordingly, a lowermost layer of the second top DBR layer 133 is the low refractive index layer 130b.

The cavity layer 132 disposed under the second top DBR layer 133 may be formed of Al_{0.31}Ga_{0.69}As, as the high refractive index layer 130a. In this case, in order to have an optical thickness of λ/2, a thickness of the cavity layer 132 may be about 1246 Å. The first top DBR layer 131 having a structure in which the low refractive index layer 130b and the high refractive index layer 130a are repeatedly stacked is disposed under the cavity layer 132. Since the cavity layer 132 is formed of the same material as that of the high refractive index layer 130a, the low refractive index layer 130b is a first layer disposed under the cavity layer 132. The high refractive index layer 130a and the low refractive index layer 130b may be repeatedly stacked, for example, 16 times, under the low refractive index layer 130b contacting the cavity layer 132. Accordingly, the second top DBR layer 133 may have 16.5 pairs of the high refractive index layer 130a and the low refractive index layer 130b. A lowermost layer of the second top DBR layer 133 is the low refractive index layer 130b.

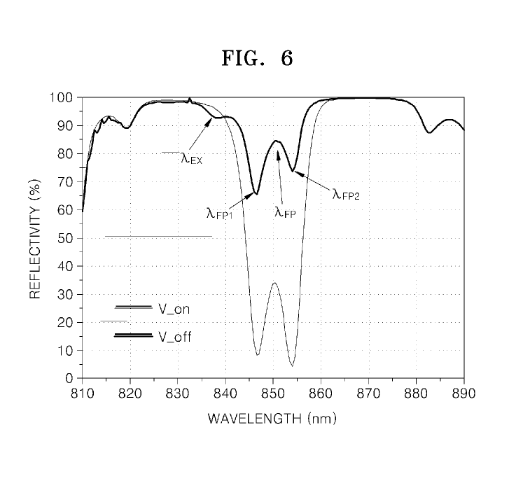

The optical modulators 100 of FIGS. 4 and 5 have the same operation characteristics. FIG. 6 is a graph illustrating operation characteristics of the optical modulator 100, particularly illustrating a reflectivity when no voltage is applied to the optical modulator 100 and a reflectivity when a voltage is applied to the optical modulators 100. Here, a voltage is a reverse bias voltage applied to the optical modulator 100. For example, a negative voltage is applied to a p-electrode of the optical modulator 100, and a positive voltage is applied to an n-electrode of the optical modulator 100. According to the graph illustrating the reflectivity when no voltage is applied to the optical modulator 100, absorption peaks occur at two resonant wavelengths λ_{FP1} and λ_{FP2} around 850 nm due to Fabry-Perot resonance by the active layer 120 and the cavity layer 132. Also, aside from the Fabry-Perot resonance, an absorption peak occurs at a wavelength λ_{EX} of about 837 nm due to exciton absorption in the quantum well layers in the active layer 120.

If a reverse voltage of about 5.7 V is applied to the optical modulator 100, an absorption wavelength of the active layer 120 is shifted to a longer wavelength due to a quantum confined stark effect. In the optical modulator 100 of FIG. 4 or 5, if a reverse voltage is applied, the wavelength λ_{EX} of about 837 nm at which the absorption peak occurs may be shifted to about 850 nm. Then, due to the Fabry-Perot resonance, light absorption in the active layer 120 may be maximized. According to the graph illustrating the reflectivity when a voltage is applied to the optical modulator 100, very large absorption peaks occur at the two resonant wavelengths λ_{FP1} and λ_{FP2} around 850 nm.

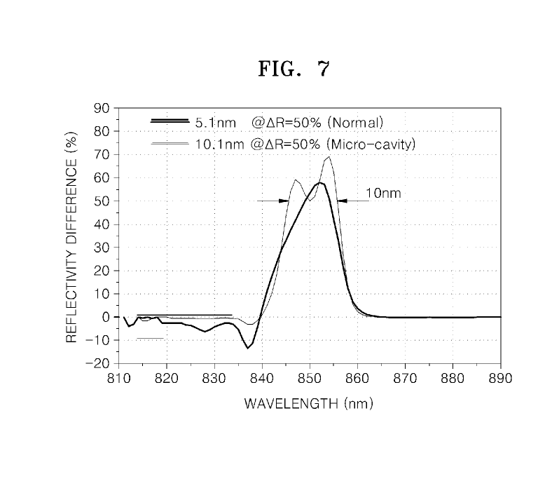

An optical modulation performance of the optical modulator 100 may be determined by using a difference between a reflectivity when no voltage is applied and a reflectivity when a voltage is applied, which is hereinafter referred to as a reflectivity difference. As a reflectivity difference increases, an optical modulation performance of the optical modulator 100 may increase. Also, as described above, considering various error factors, a high reflectivity difference may be maintained over as wide a wavelength band as possible. In this case, the wider bandwidth is advantageous to the optical modulator 100. FIG. 7 is a graph illustrating a reflectivity difference of the optical modulator 100 and a reflectivity difference of an optical modulator including only one Fabry-Perot resonant mode. Referring to FIG. 7, the optical modulator 100 according to the present exemplary embodiment has a high reflectivity difference ΔR of about 60% to 70% at two resonant wavelengths λ_{FP1} and λ_{FP2}. Also, a bandwidth with a reflectivity difference of higher than 50% is about 10.1 nm. Also, in the optical modulator including only one Fabry-Perot resonant mode, a bandwidth with a reflectivity difference of higher than 50% is about 5.1 nm. Accordingly, it is found that a bandwidth of the optical modulator 100 according to the present exemplary embodiment is about 2 times greater than that of the optical modulator including only one Fabry-Perot resonant mode.

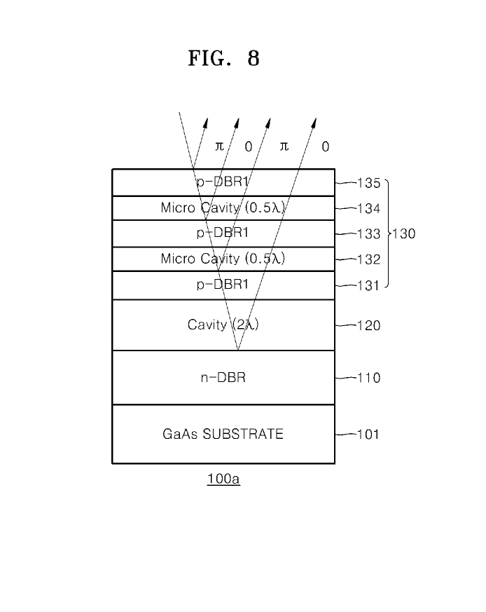

In the present exemplary embodiment, one cavity layer 132 is disposed in the top DBR layer 130. However, according to one or more other exemplary embodiments, more cavity layers 132 may be disposed in the top DBR layer 130. FIG. 8 is a cross-sectional view for explaining an operation of an optical modulator 100a including two cavity layers in the top DBR layer 130, according to another exemplary embodiment. Referring to FIG. 8, the optical modulator 100a includes 4 reflective layers, that is, the bottom DBR layer 110, the first top DBR layer 131, the second top DBR layer 133, and a third top DBR layer 135. Furthermore, the optical modulator 100a includes 3 resonant cavities, that is, the active layer 120, the first cavity layer 132, and a second cavity layer 134. The active layer 120 acts as a main resonant cavity, and the bottom DBR layer 110 and the first top DBR layer 131 are respectively disposed under and above the active layer 120 for Fabry-Perot resonance. Also, the first and second cavity layers 132 and 134 act as additional micro-resonant cavities. The first top DBR layer 131 and the second top DBR layer 133 are respectively disposed under and above the first cavity layer 132 for Fabry-Perot resonance, and the second top DBR layer 133 and the third top DBR layer 135 are respectively disposed under and above the second cavity layer 134. In order to act as a resonant cavity, each of the active layer 120 and the first and second cavity layers 132 and 134 has an optical thickness that is an integer multiple of λ/2. For example, the active layer 120 may have an optical thickness of 2λ and each of the first and second cavity layers 132 and 134 may have an optical thickness of λ/2. Although both the active layer 120 and the first and second cavity layers 132 and 134 act as resonant cavities, light absorption occurs only in the active layer 120 having a multiple quantum well layer structure and the first and second cavity layers 132 and 134 only cause Fabry-Perot resonance.

In this structure, if a light is incident on a top surface of the optical modulator 100a, 4 reflected lights with difference phases are generated. For example, a light directly reflected from the third top DBR layer 135 has a phase of π. Also, a light resonated in the second cavity layer 134 and then reflected from the second top DBR layer 133 has a phase of 0. A light resonated in the first cavity layer 132 and then reflected from the first top DBR layer 131 has a phase of π. A light resonated in the active layer 120 and then reflected from the bottom DBR layer 110 has a phase of 0. As a result, when a light travels downward, lights reflected from the four reflective layers, that is, the bottom DBR layer 110, the first top DBR layer 131, the second top DBR layer 133, and the third top DBR layer 135, have phases of π, 0, π, and 0, respectively. Then, the four reflected lights with different phases are offset from one another.

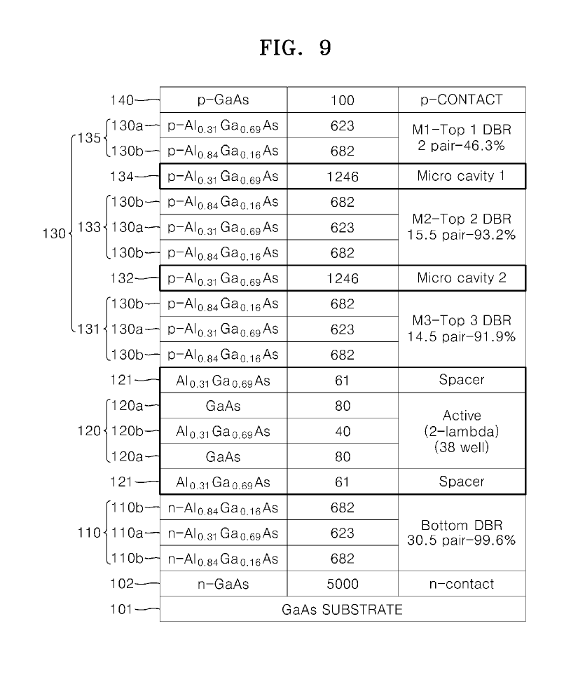

For the above operation, positions of the first and second cavity layers 132 and 134 in the top DBR layer 130 and reflectivities of the bottom DBR layer 110, the first top DBR layer 131, the second top DBR layer 133, and the third top DBR layer 135 may vary by design. FIG. 9 is a table showing optimal materials and thicknesses of layers of the optical modulator 100a of FIG. 8. The optical modulator 100a of FIG. 9 is also designed to have a center absorption wavelength of about 850 nm by using a GaAs compound semiconductor. Referring to FIG. 9, the top DBR layer 130 is disposed under the second contact layer 140 formed of p-GaAs with a thickness of about 100 Å. The top DBR layer 130 may include the third top DBR layer 135, the second cavity layer 134, the second top DBR layer 133, the first cavity layer 132, and the first top DBR layer 131 downward.

The third top DBR layer 135 has a structure in which the high refractive index layer 130a and the low refractive index layer 130b are sequentially repeatedly stacked 2 times downward. That is, the third top DBR layer 135 may include 2 pairs of the high refractive index layer 130a and the low refractive index layer 130b. As described above, the high refractive index layer 130a may be formed of Al_{0.31}Ga_{0.69}As with a thickness of about 623 Å, and the low refractive index layer 130b may be formed of Al_{0.84}Ga_{0.16}As with a thickness of about 682 Å. A reflectivity of the third top DBR layer 135 may be about 46.3%.

The second cavity layer 134 is disposed under the third top DBR layer 135. Since a lowermost layer of the third top DBR layer 135 is the low refractive index layer 130b, the second cavity layer 134 may be formed of the same material as that of the high refractive index layer 130a. In order to have an optical thickness of λ/2, the second cavity layer 134 may have a thickness that is about 1246 Å.

The second top DBR layer 133 disposed under the second cavity layer 134 has a structure in which the low refractive index layer 130b and the high refractive index layer 130a are sequentially repeatedly stacked downward. Since the second cavity layer 134 is formed of the same material as that of the high refractive index layer 130a, the low refractive index layer 130b is a first layer disposed under the second cavity layer 134. The second top DBR layer 133 may have 15.5 pairs of the low refractive index layer 130b and the high refractive index layer 130a. That is, the low refractive index layer 130b and the high refractive index layer 130a are sequentially repeatedly stacked 15 times downward, and the low refractive index layer 130b is further disposed as a lowermost layer. A reflectivity of the second top DBR layer 133 may be about 93.2%.

The first cavity layer 132 is disposed under the second top DBR layer 133. Since a lowermost layer of the second top DBR layer 133 is the low refractive index layer 130b, the first cavity layer 132 may be formed of the same material as that of the high refractive index layer 130a. In order to have an optical thickness of λ/2, the first cavity layer 132 may have a thickness that is about 1246 Å.

The first top DBR layer 131 disposed under the first cavity layer 132 has a structure in which the low refractive index layer 130b and the high refractive index layer 130a are sequentially repeatedly stacked downward. Since the first cavity layer 132 is formed of the same material as that of the high refractive index layer 130a, the low refractive index layer 130b is a first layer disposed under the first cavity layer 132. The first top DBR layer 131 may have 14.5 pairs of the low refractive index layer 130b and the high refractive index layer 130a. That is, the low refractive index layer 130b and the high refractive index layer 130a are sequentially repeatedly stacked 14 times, and the low refractive index layer 130b is further disposed as a lowermost layer. A reflectivity of the first top DBR layer 131 may be about 91.9%.

As described above, the first top DBR layer 131, the first cavity layer 132, the second top DBR layer 133, the second cavity layer 134, and the third top DBR layer 135 may be p-type doped to allow current to flow therethrough. Structures of the active layer 120, the spacer layer 121, and the bottom DBR layer 110 are the same as or similar to those described with reference to FIGS. 4 and 5. As shown in FIG. 9, even when the two cavity layers, namely, the first and second cavity layers 132 and 134, are disposed in the top DBR layer 130, the number of high refractive index layers 130a and the number of low refractive index layers 130b may not be much higher than that of FIGS. 4 and 5.

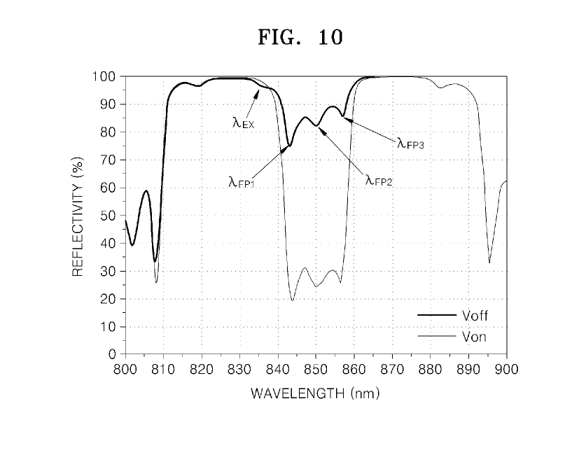

FIG. 10 is a graph illustrating a reflectivity when no voltage is applied to the optical modulator 100a of FIG. 9 and a reflectivity when a voltage is applied to the optical modulator 100a. According to the graph illustrating the reflectivity when no voltage is applied to the optical modulator 100a, absorption peaks occur at three resonance wavelengths λ_{FP1}, λ_{FP2}, and λ_{FP3} around 850 nm due to Fabry-Perot resonance by the active layer 120, the first cavity layer 132, and the second cavity layer 134. That is, since the optical modulator 100a includes three resonant cavities, there are three Fabry-Perot resonant modes. Here, center values of the three resonant wavelengths λ_{FP1}, λ_{FP2}, and λ_{FP3} may be equal to 850 nm, which is a wavelength of an incident light to be modulated. Also, aside from the Fabry-Perot resonance, an absorption peak occurs at a wavelength λ_{EX} of about 837 nm due to exciton absorption in the quantum well layers in the active layer 120.

If a reverse voltage of about 6 V is applied to the optical modulator 100a, an absorption wavelength of the active layer 120 is shifted to a longer wavelength due to a quantum confined stark effect. For example, if a reverse voltage is applied to the optical modulator 100a, the wavelength λ_{EX} of about 837 nm at which the absorption peak occurs may be shifted to about 850 nm. Then, due to the Fabry-Perot resonance, light absorption in the active layer 120 may be maximized. According to the graph illustrating the reflectivity when a voltage is applied to the optical modulator 100a, very large absorption peaks occur at the three resonant wavelengths λ_{FP1}, λ_{FP2}, and λ_{FP3} around 850 nm. Depths of such absorption peaks may be finely adjusted by adjusting reflectivities of the bottom DBR layer 110, the first top DBR layer 131, the second top DBR layer 133, and the third top DBR layer 135 in the optical modulator 100a.

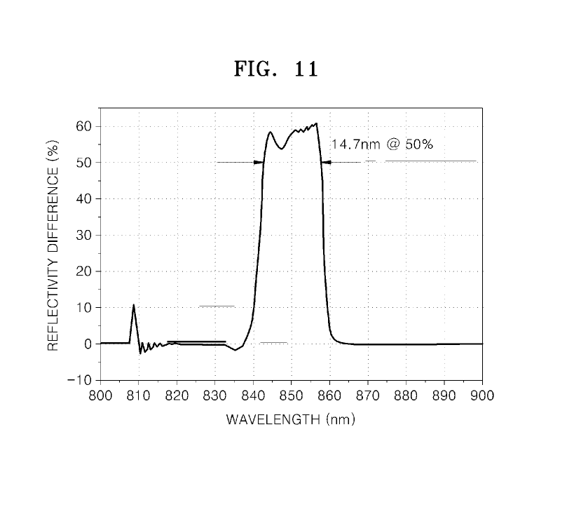

FIG. 11 is a graph illustrating a reflectivity difference of the optical modulator 100a. Referring to FIG. 11, the optical modulator 100a has a relatively constant reflectivity difference ΔR of about 60% in the three resonant wavelengths λ_{FP1}, λ_{FP2}, and λ_{FP3}. Also, a bandwidth with a reflectivity difference of higher than 50% is about 14.7 nm, which is relatively wide. Accordingly, as the number of Fabry-Perot resonant modes increases, a bandwidth with a reflectivity difference of higher than 50% increases and a smoothness of a peak of a reflective difference increases as well.

Although the optical modulator 100 includes two cavity layers, namely, the first and second cavity layers 132 and 134, in FIGS. 8 and 9, more cavity layers may be disposed according to one or more other exemplary embodiments. Also, although both the two cavity layers, namely, the first and second cavity layers 132 and 134, are formed of the same material as that of the high refractive index layer 130a, it is understood that one or more other exemplary embodiments are not limited thereto. For example, one of the two cavity layers, namely, the first and second cavity layers 132 and 134, may be formed of a material of the high refractive index layer 130a, and the other may be formed of a material of the low refractive index layer 130b. Also, both the two cavity layers, namely, the first and second cavity layers 132 and 134, may be formed of a material of the low refractive index layer 130b. However, in this case, in order not to change an order in which the high refractive index layer 130a and the low refractive index layer 130b are repeatedly stacked in the top DBR layer 130, structures of the first top DBR layer 131, the second top DBR layer 133, and the third top DBR layer 135 are to be changed. For example, if the second cavity layer 134 is formed of a material of the low refractive index layer 130b, the third top DBR layer 135 may include 1.5 or 2.5 pairs of the high refractive index layer 130a and the low refractive index layer 130b.

The above explanation has been made on the assumption that a light is perpendicularly incident on the optical modulators 100 and 100a. However, if the optical modulators 100 and 100a are applied to an apparatus for capturing a 3D image, such as a 3D camera, a light may be obliquely incident on the optical modulators 100 and 100a according to an arrangement of an optical system. In particular, if a lens for focusing a light is disposed at the front of the optical modulator 100 or 100a, a light may be incident on the optical modulators 100 and 100a at various angles within a predetermined range. If a light is obliquely incident, a length of an optical path is different from that when a light is perpendicularly incident. Accordingly, resonance characteristics when a light is obliquely incident are also different from those when a light is perpendicularly incident. Accordingly, in order to achieve desired operation characteristics for an obliquely incident light, thicknesses of layers of the optical modulator 100 or 100a may be determined in consideration of an incident angle of the light.

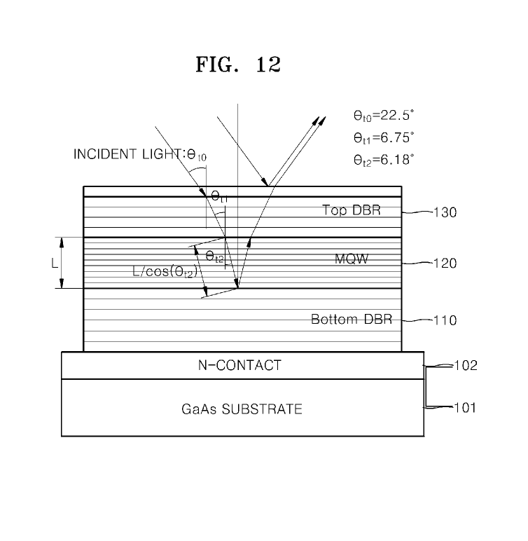

FIG. 12 is a cross-sectional view illustrating an optical path according to an incident angle of an obliquely incident light incident on the optical modulator 100 or 100a. In FIG. 12, a cavity layer is assumed to be a part of the top DBR layer 130 for convenience. Referring to FIG. 12, an obliquely incident light, which is incident on the optical modulator 100 or 100a from the outside, passes through the top DBR layer 130 and the active layer 120, and then is reflected from the bottom DBR layer 110. In this case, the obliquely incident light sequentially passes through three media with different refractive indices, that is, external air, the top DBR layer 130, and the active layer 120. Accordingly, the obliquely incident light is refracted from an interface between the air and the top DBR layer 130, and an interface between the top DBR layer 130 and the active layer 120. When an incident angle at which the obliquely incident light is incident on the top DBR layer 130 is θₜ₀, a refraction angle θₜ₁ at the top DBR layer 130 and a refraction angle θₜ₂ at the active layer 120 may be easily calculated by using Snell's law. Here, since each of the top DBR layer 130 and the active layer 120 include a plurality of materials with different refractive indices, an average refractive index of the refractive indices of the materials is used as a refractive index of each of the top DBR layer 130 and the active layer 120. For example, in the optical modulator 100 illustrated in FIG. 4 or 5, if θₜ₀=22.5°, θₜ₁=6.75°, and θₜ₂=6.18°.

In general, when a light is incident on a resonant cavity at an incident angle of θₜ, the following relationship (m+½)k=2 nL cos(θₜ) is established. Here, m is a positive integer including 0, λ is a resonant wavelength, n is a refractive index of the resonant cavity, and L is a thickness of the resonant cavity. As shown in the above relationship, if the refractive index n and the thickness L of the resonant cavity are fixed, the resonant wavelength λ is proportional to cos(θₜ). That is, as the incident angle θₜ increases, the resonant wavelength λ decreases. Accordingly, in order to compensate for the effect of an incident angle of an incident light in a state where the resonant wavelength λ is fixed, the thickness L of the resonant cavity is multiplied by 1/cos(θₜ). Referring back to FIG. 12, when a light is obliquely incident on the optical modulator 100 or 100a at an incident angle of θₜ₀, if a thickness of the top DBR layer 130 is increased by 1/cos(θₜ₁) and a thickness of the active layer 120 is increased by 1/cos(θₜ₂), the effect of an oblique entrance may be compensated for.

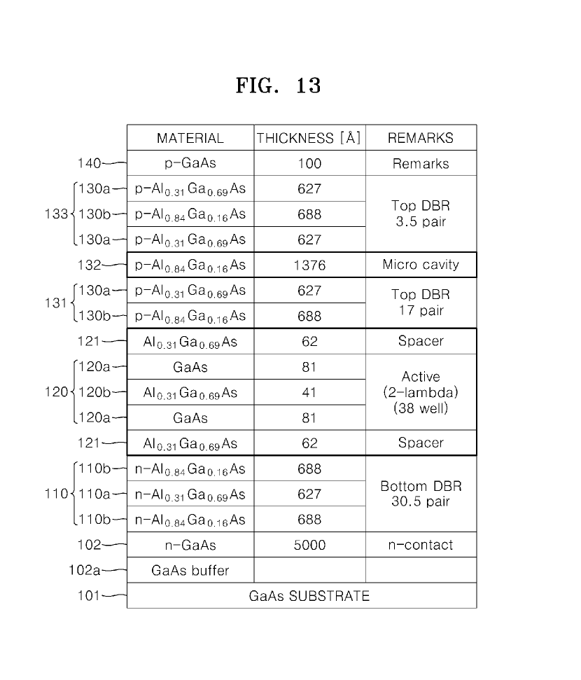

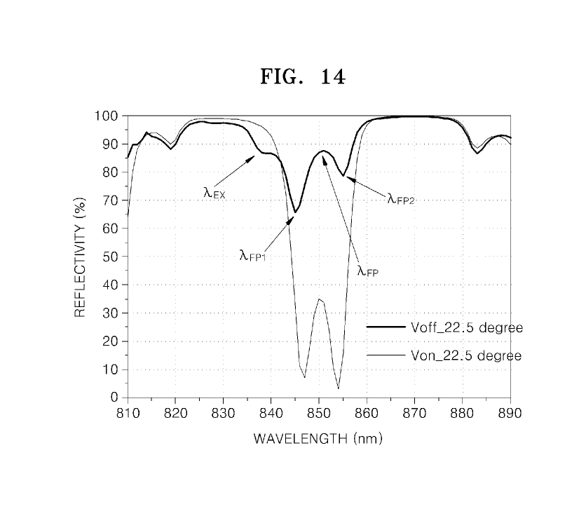

FIG. 13 is a table showing a modified optical modulator of the optical modulator 100 of FIG. 4, which may compensate for an effect when θₜ₀=22.5°. Referring to FIG. 13, a thickness of each of the top DBR layer 130 and the bottom DBR layer 110 is higher by 1/cos)(6.75°) than that in the optical modulator 100 of FIG. 4, and a thickness of the active layer 120 is higher by 1/cos(6.18°) than that in the optical modulator 100 of FIG. 4. FIGS. 14 and 15 are graphs illustrating operation characteristics of the modified optical modulator of FIG. 13. Referring to FIG. 14, large absorption peaks occur at two resonant wavelengths λ_{FP1} and λ_{FP2} around 850 nm. When compared with the graphs of FIGS. 6 and 7, operation characteristics when a light is perpendicularly incident and when a light is obliquely incident after adjusting thicknesses of layers of the modified optical modulator are almost the same. Although θₜ₀=22.5° in FIG. 13, thicknesses of layers of the modified optical modulator may be adjusted in the same manner even when the incident angle θₜ₀ is different from 22.5°. Also, although the modified optical modulator of the optical modulator of FIG. 4 is illustrated in FIG. 13, the aforesaid principle may apply to the optical modulators 100 and 100a of FIGS. 5 and 9 and other optical modulators according to other exemplary embodiments.

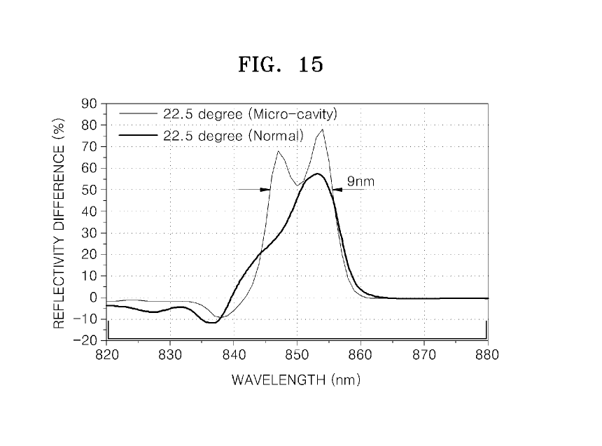

Also, FIG. 16 is a cross-sectional view illustrating an example where a light is focused by a lens 150 on a surface of an optical modulator according to an exemplary embodiment. Referring to FIG. 16, if the light is focused on the surface of the optical modulator by using the lens 150, the light may be incident on the optical modulator at various angles within a predetermined range. For example, a light may be incident on the optical modulator at an angle within about ±20 degrees on the basis of a center incident angle. For example, if a center incident angle is 22.5°, an incident angle of a light incident on the optical modulator may range from 2.5° to 42.5°. If the optical modulator is designed in consideration of a light incident at a center incident angle, since the resonant wavelength λ is proportional to cos(θₜ) (where θₜ is an incident angle) as described above, a resonant wavelength for a light incident at an angle greater than the center incident angle is decreased (that is, a blue shift occurs), and a resonant wavelength for a light incident at an angle less than the center incident angle is increased (that is, a red shift occurs).

Also, since a wavelength λ_{EX} of about 837 nm at which exciton absorption occurs is irrelevant to a structure of a resonant cavity, the wavelength λ_{EX} is maintained constant even though an incident angle of a light is changed. Accordingly, if an incident angle of an incident light is too large, a resonant wavelength may be close to an exciton absorption wavelength. If the resonant wavelength and the exciton absorption wavelength are close to each other, large light absorption may occur and the optical modulation performance of the optical modulator may be degraded. Accordingly, when the optical modulator is used, an incident angle may be limited such that a resonance wavelength is not too close to an exciton absorption wavelength. For example, a maximum incident angle of an incident light may be limited to satisfy a relationship λ_{EX}+10 nm<λ_{FP1} (where λ_{FP1} is a shortest resonant wavelength from among a plurality of resonant wavelengths). An allowable maximum incident angle may vary according to design of the optical modulator. For example, based on the relationship (m+½)λ=2 nL cos(θₜ), if thicknesses of the top DBR layer 130 and the active layer 120 are increased by 1/cos(θₜ), the allowable maximum incident angle may be increased by θₜ. However, the fact that as an incident angle increases, a change in a resonant wavelength may increase needs to be considered when the allowable maximum incident angle is determined.

Also, in order to apply an optical modulator to an apparatus for capturing a 3D image, a large area as well as a wide absorption bandwidth may be used. However, once the optical modulator is made large, an electrostatic capacitance of the optical modulator is increased. The increase in the electrostatic capacitance of the optical modulator increases an RC time constant, thereby making it difficult to drive the optical modulator at a high speed of 20 to 40 MHz. Accordingly, there is a demand for a structure that may increase an entire area of the optical modulator and reduce an electrostatic capacitance and a sheet resistance.

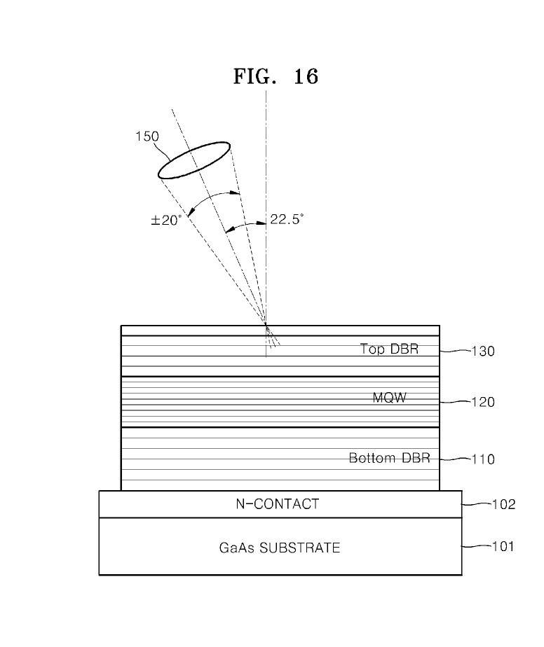

FIG. 17 is a plan view illustrating an optical modulator array 200 including an array of optical modulators 100 in order to reduce an electrostatic capacitance according to an exemplary embodiment. In FIG. 17, the plurality of optical modulators 100 are arranged in a 2×3 array. However, the arrangement of the optical modulators 100 is not limited to the 2×3 array, and may be an n×m array (where n and m are natural numbers greater than 1) according to design. The optical modulator 100 of a unit cell may have a rectangular shape with a size of, for example, 2 mm×0.5 mm to 4 mm×1 mm. Referring to FIG. 17, the plurality of optical modulators 100 are arranged in an insulating frame 201. Each of the plurality of optical modulators 100 is electrically separated from another optical modulator 100 by the insulating frame 201. A trench 202 is formed (i.e., located) around the optical modulator 100 of each unit cell by etching the insulating frame 201. A width of the trench 202 may be, for example, about 20 to 50 μm. Also, an insulating film 211 may be formed on a sidewall of the optical modulator 100. A plurality of first electrode pads 203 and second electrode pads 204 are arranged on a top surface of the insulating frame 201. The first and second electrode pads 203 and 204 are respectively electrically connected to electrodes of the optical modulators 100. For example, the second electrode pad 204 is electrically connected to a second electrode 206 disposed on a top surface of the optical modulator 100. Also, the first electrode pad 203 is electrically connected to a first electrode 205 disposed on a bottom surface of the trench 202 that surrounds the optical modulator 100. As shown in FIG. 17, the first electrode 205 may be formed on the bottom surface of the trench 202 to surround the optical modulator 100.

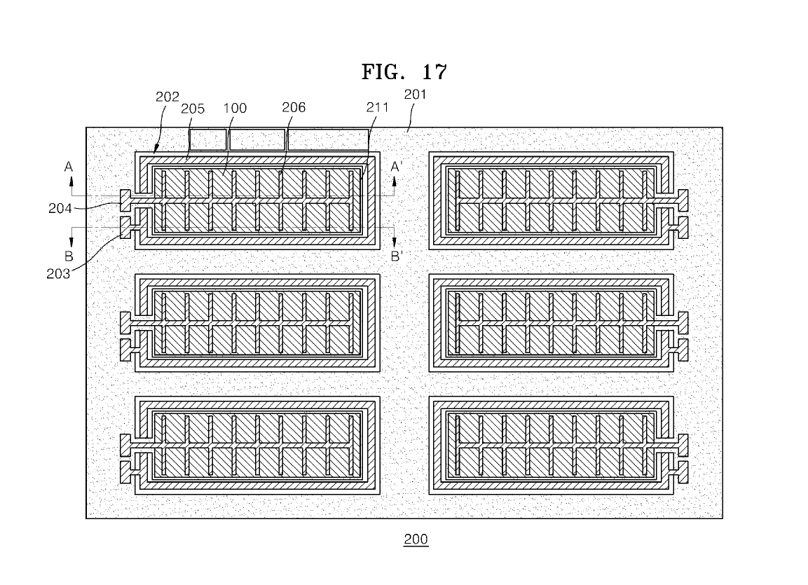

FIG. 18 is a cross-sectional view taken along line A-A′ of FIG. 17. FIG. 18 illustrates only a cross-sectional view of one optical modulator 100 in the optical modulator array 200 for convenience of description. Referring to FIG. 18, the optical modulator 100 includes the substrate 101, the first contact layer 102, the bottom DBR layer 110, the active layer 120, the first top DBR layer 131, the cavity layer 132, the second top DBR layer 133, and the second contact layer 140. Although the optical modulator 100 includes only one cavity layer 132, as illustrated in FIGS. 17 and 18, it is understood that another exemplary embodiment is not limited thereto. For example, the optical modulator 100a including two cavity layers, namely, the first and second cavity layers 132 and 134, may be used. The trench 202 is formed (i.e., located) in a right side of the optical modulator 100 to expose the first contact layer 102. The first electrode 205 is disposed on the bottom surface of the trench 202 to contact the first contact layer 102. The insulating film 211 is formed on the sidewall of the optical modulator 100, and the insulating frame 201 for electrically separating the optical modulator 100 from another adjacent optical modulator is formed at a right side of the trench 202. Also, the insulating frame 201 is formed on a left side of the optical modulator 100. Each of the insulating frame 201 and the insulating film 211 may be formed of, for example, benzocyclobutene (BCB). The second electrode pad 204 is disposed on a top surface of the insulating frame 201 that is formed on the left side of the optical modulator 100. In order to increase an adhesive force with the second electrode pad 204 formed of a metal, an adhesive layer 210 formed of, for example, SiO₂, may be further disposed between the insulating frame 201 and the second electrode pad 204. The second electrode pad 204 is electrically connected to a second electrode 206 disposed on the second contact layer 140.

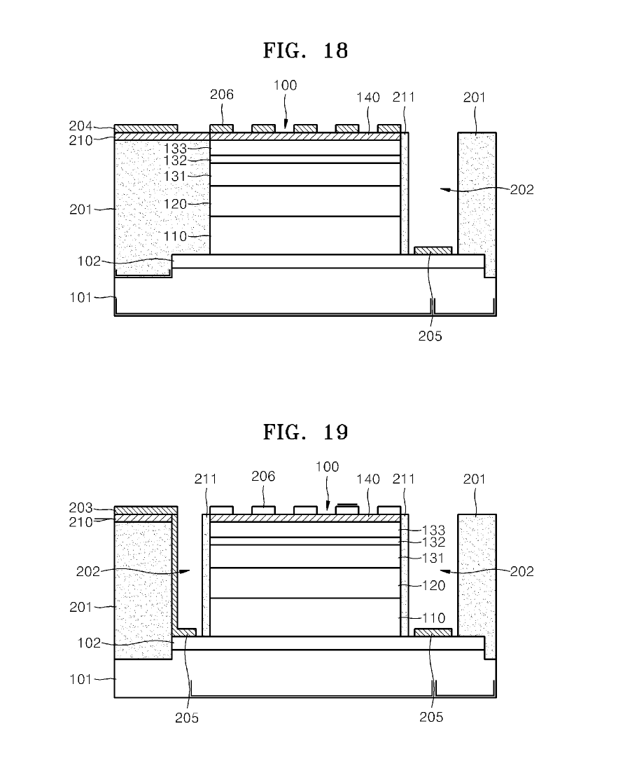

FIG. 19 is a cross-sectional view taken along line B-B′ of FIG. 17. Referring to FIG. 19, the trench 202 is formed in both sides of the optical modulator 100 to expose the first contact layer 102. The first electrode 205 is disposed on the bottom surface of the trench 202 to contact the first contact layer 102. Although two first electrodes 205 are illustrated in FIG. 19, they may be one electrode connected along the bottom surface of the trench 202 to surround the optical modulator 100. For example, the first electrode 205 may have a square ring shape along the trench 202 to surround the optical modulator 100. Also, the insulating film 211 may be formed on both side surfaces of the optical modulator 100. Also, the insulating frame 201 is disposed with the trench 202 therebetween. As shown in FIG. 19, the first electrode pad 203 is disposed on a top surface of the insulating frame 201. In order to increase an adhesive force with the first electrode pad 203, the adhesive layer 210 formed of, for example, SiO₂, may be further disposed between the insulating frame 201 and the first electrode pad 203. The first electrode 205 may extend along a sidewall of the trench 202 to be electrically connected to the first electrode pad 203.

Referring back to FIG. 17, the second electrode 206 formed on the top surface of the optical modulator 100 may have a lattice shape in order to reduce resistance. For example, the second electrode 206 having a lattice shape, for example, a fishbone shape, is illustrated in FIG. 17. However, the second electrode 206 is not limited to the fishbone shape and may have a lattice shape such as a matrix shape or a mesh shape. In this case, since an entire width of the second electrode 206 is reduced, a sheet resistance may be reduced. If the second electrode 206 is formed of a metal material, a light incident on the optical modulator 100 may be partially blocked by the second electrode 206. Accordingly, in order to minimize light loss, a width of a lattice may be small, for example, about 10 to 20 μm. The second electrode 206 may be formed of a single metal material or the second electrode 206 may be formed to have a multi-layer structure in which, for example, platinum (Pt), titanium (Ti), platinum (Pt), and gold (Au) are sequentially stacked. Also, the second electrode 206 may be formed of a material such as indium tin oxide (ITO), zinc oxide (ZnO), aluminum zinc oxide (AZO) through which a light may be transmitted.

In the aforesaid optical modulator array 200, since the optical modulators 100 are divided into a plurality of cells, an electrostatic capacitance may be reduced. Also, since the first electrode 205 and the second electrode 206 are not disposed to directly face each other, a parasitic electrostatic capacitance may be prevented from being generated. For example, the first electrode 205 is disposed around the optical modulator 100 of a unit cell whereas the second electrode 206 is disposed at a central portion of the optical modulator 100. Also, since an area of the first electrode 205 and an area of the second electrode 206 may be reduced, a sheet resistance of each of the first electrode 205 and the second electrode 206 may be reduced and generation of a parasitic electrostatic capacitance may be further reduced.

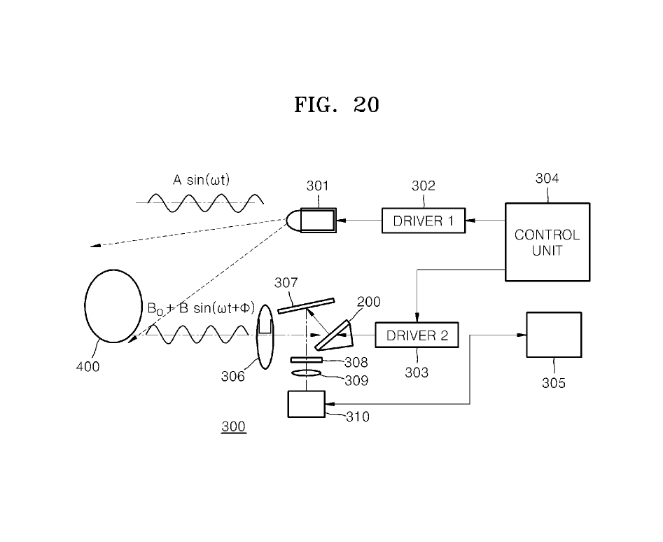

FIG. 20 is a view illustrating an apparatus 300 for capturing a 3D image including the optical modulator array 200 according to an exemplary embodiment. Referring to FIG. 20, the apparatus 300 may include a light source 301 that generates a light having a predetermined wavelength, a first driver 302 that drives the light source 301, an objective lens 306 that focuses a light reflected from an object 400, the optical modulator array 200 that modulates a light reflected from the object 400, a second driver 303 that drives the optical modulator array 200, an imager 310 that generates an image from the modulated light, a calculator 305 that calculates a distance to the object 400 based on an output of the imager 310, and a controller 304 that controls operations of the first and second drivers 302 and 303. Also, a mirror 307 that reflects a light modulated and reflected by the optical modulator array 200 and a filter 308 that transmits only a light emitted from the light source 301 may further be disposed in front of the imager 310. A lens 309 that focuses a modulated light on an area of the imager 315 may be further disposed between the imager 310 and the filter 308. Also, the optical modulator 100 or 100a of FIG. 1 or 9 may be used instead of the optical modulator array 200.

The light source 301 may be, for example, a light-emitting diode (LED) or a laser diode (LD) that may emit a light having a near-infrared (NIR) wavelength of about 850 nm, which is invisible to human eyes, for safety. In this case, the filter 308 may be an infrared pass filter that transmits a light of about 850 nm. The first driver 302 may emit a periodic wave such as a sinusoidal wave by driving the light source 301 according to a control signal received from the controller 304. After a light projected to the object 400 from the light source 301 is reflected from the object 400, the light is focused on the optical modulator array 200 by the objective lens 306. Then, the optical modulator array 200 modulates the incident light into a modulated signal having a predetermined wavelength according to a control of the second driver 303. The second driver 303 may control the modulated signal of the optical modulator array 200 according to a control signal received from the controller 304. After the modulated light is reflected from the optical modulator array 200, the light is reflected again from the mirror 307 and is incident on the imager 310. In this case, a component other than an NIR component of 850 nm is removed by the filter 308. The imager 310 generates an image containing distance information by capturing the light reflected by the optical modulator array 200. For example, the imager 310 may be a charge-coupled device (CCD) image sensor or a complementary metal-oxide semiconductor (CMOS) image sensor including a two-dimensional (2D) array. The calculator 305 may calculate a distance to the object 400 according to a distance calculation algorithm based on an output of the imager 310.

While exemplary embodiments have been particularly shown and described above using specific terms, the exemplary embodiments and terms have been used to explain the present inventive concept and should not be construed as limiting the scope of the present inventive concept defined by the claims. The exemplary embodiments should be considered in a descriptive sense only and not for purposes of limitation. Therefore, the scope of the invention is defined not by the detailed description of exemplary embodiments, but by the appended claims, and all differences within the scope will be construed as being included in the present invention.

What is claimed is:

1. An optical modulator comprising:
a bottom reflective layer;
an active layer which is disposed on the bottom reflective layer and which comprises a multiple quantum well layer;
a top reflective layer which is disposed on the active layer; and
at least one cavity layer which is disposed in the top reflective layer,
wherein, when a center wavelength of an incident light to be modulated is λ, each of the active layer and the at least one cavity layer has an optical thickness that is an integer multiple of λ/2 to provide an individual resonant cavity.

2. The optical modulator of claim 1, wherein the optical thickness of the active layer is 2λ, and the optical thickness of the at least one cavity layer is λ/2.

3. The optical modulator of claim 1, wherein:
one cavity layer is disposed in the top reflective layer; and
the top reflective layer comprises a first top reflective layer which is disposed on the active layer, the one cavity layer which is disposed on the first top reflective layer, and a second top reflective layer which is disposed on the one cavity layer.

4. The optical modulator of claim 3, wherein a phase of a light directly reflected from the second top reflective layer is π, and a phase of each of a light resonated in the one cavity layer and then reflected from the first top reflective layer and a light resonated in the active layer and then reflected from the bottom reflective layer is 0.

5. The optical modulator of claim 3, wherein each of the bottom reflective layer, the first top reflective layer, and the second top reflective layer is a distributed Bragg reflective (DBR) layer where a first refractive index layer and a second refractive index layer with different refractive indices are repeatedly alternately stacked, each of the first and second refractive index layers having an optical thickness of λ/4.

6. The optical modulator of claim 5, wherein the one cavity layer is formed of a material of the first refractive index layer or a material of the second refractive index layer.

7. The optical modulator of claim 6, wherein the one cavity layer is formed of the material of the first refractive index layer, the second refractive index layer of the first top reflective layer is disposed under the one cavity layer to contact the one cavity layer, and the second refractive index layer of the second top reflective layer is disposed above the one cavity layer to contact the one cavity layer.

8. The optical modulator of claim 6, wherein, the one cavity layer is formed of the material of the second refractive index layer, the first refractive index layer of the first top reflective layer is disposed under the one cavity layer to contact the one cavity layer, and the first refractive index layer of the second top reflective layer is disposed above the one cavity layer to contact the one cavity layer.

9. The optical modulator of claim 5, wherein the first refractive index layer comprises AlₓGa₁₋ₓAs, the second refractive index layer comprises Al_{y}Ga_{1-y}As, and 0<x<1, 0<y<1, and x<y.

10. The optical modulator of claim 3, wherein a reflectivity of the bottom reflective layer is about 98% to 99%, a reflectivity of the first top reflective layer is about 90%, and a reflectivity of the second top reflective layer is about 60% to 70%.

11. The optical modulator of claim 3, wherein two Fabry-Perot resonant modes occur due to the active layer and the one cavity layer, and center values of two resonant wavelengths are equal to the center wavelength λ of the incident light to be modulated.

12. The optical modulator of claim 1, wherein:
two cavity layers are disposed in the top reflective layer,
wherein the top reflective layer comprises a first top reflective layer which is disposed on the active layer, a first cavity layer which is disposed on the first top reflective layer, a second top reflective layer which is disposed on the first cavity layer, a second cavity layer which is disposed on the second top reflective layer, and a third top reflective layer which is disposed on the second cavity layer.

13. The optical modulator of claim 12, wherein a phase of a light directly reflected from the third top reflective layer is π, a phase of a light resonated in the second cavity layer and then reflected from the second reflective layer is 0, a phase of a light resonated in the first cavity layer and reflected from the first top reflective layer is π, and a phase of a light resonated in the active layer and then reflected from the bottom reflective layer is 0.

14. The optical modulator of claim 12, wherein each of the bottom reflective layer and the first through third top reflective layers is a DBR layer where a first refractive index layer and a second refractive index layer with different refractive indices are repeatedly alternately stacked, each of the first and second refractive index layers having an optical thickness of λ/4.

15. The optical modulator of claim 14, wherein the first cavity layer is formed of a material of the first refractive index layer or a material of the second refractive index layer, and the second cavity layer is formed of the material of the first refractive index layer or the material of the second refractive index layer.

16. The optical modulator of claim 15, wherein:
if the first cavity layer is formed of the material of the first refractive index layer, the second refractive index layer of the first top reflective layer is disposed under the first cavity layer to contact the first cavity layer, and the second refractive index layer of the second top reflective layer is disposed above the first cavity layer to contact the first cavity layer; and
if the first cavity layer is formed of the material of the second refractive index layer, the first refractive index layer of the first top reflective layer is disposed under the first cavity layer to contact the first cavity layer, and the first refractive index layer of the second top reflective layer is disposed above the first cavity layer to contact the first cavity layer.

17. The optical modulator of claim 15, wherein:
if the second cavity layer is formed of the material of the first refractive index layer, the second refractive index layer of the second top reflective layer is disposed under the second cavity layer to contact the second cavity layer, and the second refractive index layer of the third top reflective layer is disposed above the second cavity layer to contact the second cavity layer; and
the second cavity layer is formed of the material of the second refractive index layer, the first refractive index layer of the second top reflective layer is disposed under the second cavity layer to contact the second cavity layer, and the first refractive index layer of the third top reflective layer is disposed above the second cavity layer to contact the second cavity layer.

18. The optical modulator of claim 12, wherein a reflectivity of the bottom reflective layer is about 98% to 99%, a reflectivity of the first top reflective layer is about 91%, a reflectivity of the second top reflective layer is about 93%, and a reflectivity of the third top reflective layer is about 46%.

19. The optical modulator of claim 12, wherein three Fabry-Perot resonant modes occur due to the active layer and the first and second cavity layers, and center values of three resonant wavelengths are equal to the center wavelength λ of the incident light to be modulated.

20. The optical modulator of claim 1, wherein, when an exciton absorption wavelength due to the active layer is λ_{EX} and a shortest resonant wavelength from among resonant wavelengths of Fabry-Perot resonant modes generated due to the at least one cavity layer is λ_{FP1}, λEX+10 nm<λF_{FP1}.

21. The optical modulator of claim 1, wherein each of the bottom reflective layer and the top reflective layer is a DBR layer where a first refractive index layer and a second refractive index layer with difference refractive indices are repeatedly alternately stacked, and the active layer comprises a plurality of barrier layers and a plurality of quantum well layers which are alternately disposed, wherein each of the first and second refractive index layers has an optical thickness of λ/4.

22. The optical modulator of claim 21, wherein, when an incident angle of the incident light on a surface of the top reflective layer is θₜ₀, a refraction angle of the incident light on the top reflective layer is θₜ₁, and a refraction angle of the incident light on the active layer is θₜ₂, thicknesses of the first and second refractive index layers and a thickness of the cavity layer are increased by a multiple of a reciprocal of cos(θₜ₁) and a thickness of the active layer is increased by a multiple of a reciprocal of cos(θₜ₁).

23. The optical modulator of claim 1, further comprising:
a first contact layer which is disposed under the bottom reflective layer;
a substrate which is disposed under the first contact layer; and
a second contact layer which is disposed above the top reflective layer.

24. An optical modulator array comprising:
an insulating frame;
a plurality of the optical modulators of claim 1 which are arranged within the insulating frame;
a trench which surrounds each of the optical modulators;
a first electrode which is disposed on a bottom surface of the trench;
a second electrode which is disposed on a top surface of each of the optical modulators;
a first electrode pad which is disposed on a top surface of the insulating frame and is electrically connected to the first electrode; and
a second electrode pad which is disposed on the top surface of the insulating frame and is electrically connected to the second electrode.

25. The optical modulator array of claim 24, further comprising an insulating film which surrounds a sidewall of the optical modulators.

26. The optical modulator array of claim 24, further comprising an adhesive layer which is disposed between the first electrode pad and the insulating frame and between the second electrode pad and the insulating frame.

27. The optical modulator array of claim 24, wherein a first contact layer, which is disposed under the bottom reflective layer of the optical modulator, is disposed on the bottom surface of the trench, and the first electrode is disposed on the first contact layer.

28. The optical modulator array of claim 24, wherein the first electrode extends along a sidewall of the trench to be electrically connected to the first electrode pad.

29. The optical modulator array of claim 24, wherein the second electrode has a lattice shape.

30. The optical modulator array of claim 29, wherein the second electrode has a fishbone shape or a matrix shape.

31. An apparatus for capturing a three-dimensional (3D) image, the apparatus comprising:
a light source which projects light to an object;
the optical modulator of claim 1 which modulates the light reflected from the object;
an imager which captures the light modulated by the optical modulator and generates an image according to the captured light; and
a calculator which calculates a distance to the object by using the image generated by the imager.

32. An apparatus for capturing a three-dimensional (3D) image, the apparatus comprising:
a light source which projects a light to an object;
the optical modulator array of claim 24 which modulates the light reflected from the object;
an imager which captures the light modulated by the optical modulator array and generates an image according to the captured light; and
a calculator which calculates a distance to the object by using the image generated by the imager.
